(19) United States
(12) Patent Application Publication
(10) Pub. No.: US 2003/0157959 A1
(43) Pub. Date: Aug. 21, 2003

(54) Method, system, apparatus and computer program product for portable networking of multi-user applications

(76) Inventors: Jakke Makela, Turku (FI); Jukka-Pekka Vihmalo, Tampere (FI); Arto Lammintaus, Pirkkala (FI)

Correspondence Address: MORGAN & FINNEGAN, L.L.P., 345 Park Avenue, New York, NY, 10154-0053, US

(21) Appl. No.: 10/042,344

(22) Filed: Jan. 11, 2002

(51) Int. Cl. G06F 15/16; H04B 1/38

(52) U.S. Cl. 455/556; 709/203

(57) ABSTRACT

A method, system, apparatus and computer program product for portable networking of multi-user applications for users of hand-held terminals. More specifically, the present invention utilizes a portable server with a mass memory for storing multi-user data used by users of the hand-held terminals. The server has the capability of storing various types of multi-user data and transmitting the data to a user of a terminal upon request. Using the present invention, terminals have increased flexibility for receiving and utilizing multi-user data without requiring large amounts of memory within the terminal itself.

### FIELD OF THE INVENTION

A method, system, apparatus and computer program product for portable networking of multi-user applications is disclosed. In particular, the system, method, apparatus and computer program product provides a portable server containing a mass memory for storing multi-user data for use by hand-held wireless terminals. The server transmits data to at least one terminal via a wireless link using a standard protocol.

### BACKGROUND OF THE INVENTION

Hand-held communication devices are now used in many aspects of every day life. Additionally, the size of the hand-held devices is decreasing while the number of peripherals that can communicate with hand-held terminals is increasing. One popular use of hand-held terminals involve multi-user applications (e.g., games). Such applications require a large amount of memory in the terminals or the use of a central server with mass memory that can transmit relevant data to the terminal.

Although hand-held terminals and servers have become dramatically smaller, they typically require a physical interface between the hand-held terminals and a server. One such interface can be a cable running from one of the hand-held terminals to the server or the use of a docking station that acts as an interface between the server and the terminal when transfer of data is necessary. However, cables can be cumbersome and the terminal may be limited by the number of usable ports on the terminal as well as by the length of the cable. Additionally, the use of cable connections between hand-held terminals and a server severely reduces the efficiency gained by making the units smaller, and the loss of mobility and flexibility defeats the purpose for having a portable terminal.

Attempts have been made to alleviate some of these problems associated with the use of cable connections. One attempted solution has been to set up Local Area Networks or Personal Area Networks utilizing various forms of wireless communications. An example of wireless local area network technology is the Bluetooth Standard, which operates in the 2.4 GHz industrial scientific medical (ISM) band. Bluetooth is a short-range radio network, originally intended as a cable replacement. It can be used to create ad hoc networks of up to eight devices operating together. The Bluetooth Special Interest Group, Specification Of The Bluetooth System, Volumes 1 and 2, Core and Profiles: Version 1.1, 22^{nd} February, 2001, describes the principles of Bluetooth device operation and communication protocols. Bluetooth devices are designed to find other Bluetooth devices within their ten-meter radio communications range and to discover what services they offer, using a service discovery protocol (SDP).

An example of wireless local area network technology include the IEEE 802.11 Wireless LAN Standard and the HIPERLAN Standard, which operate in the 5 GHz U-NII band. The IEEE 802.11 Wireless LAN Standard is published in three parts as IEEE 802.11-1999; IEEE 802.11a-1999; and IEEE 802.11b-1999, which are available from the IEEE, Inc. web site http://grouper.ieee.org/groups/802/11. An overview of the HIPERLAN Type 2 principles of operation is provided in the Broadband Radio Access Networks (BRAN), HIPERLAN Type 2: System Overview, ETSI TR 101 683 VI.I.1 (2000-02).

However, none of these systems suggest the use of a portable server in wireless communication with hand-held terminals as a means of increasing efficiency and flexibility of using multi-user applications.

Thus, it is desirable to provide a system, method, apparatus and computer program product that provides more efficient and flexible networking of multi-user applications for users of hand-held terminals. The method, system, apparatus and computer program product of the present invention disclosed herein address this need.

### SUMMARY OF THE INVENTION

To overcome limitations in the prior art described above, and to overcome other limitations that will be apparent upon reading and understanding the present specification, the present invention is directed to providing a method, system, apparatus and computer program product for portable networking of multi-user applications for users of hand-held terminals. More specifically, the present invention utilizes a portable server with a mass memory for storing multi-user data. The server has the capability of both storing and transmitting multi-user data via a wireless link. Using the present invention, users of hand-held terminals have increased flexibility for receiving and utilizing multi-user data without requiring large amounts of memory or major redesign of existing hand-held terminals.

It is contemplated by the invention that both the server and the hand-held terminals are equipped with a wireless interface for communication of multi-user data via a wireless link using a standard wireless protocol.

It is also contemplated by the invention that the terminals will have processor and enough RAM to utilized the multi-user data received from the server.

It is also contemplated by the invention that the server will transmit multi-user data to one or many hand-held terminals wirelessly.

It is also contemplated by the invention that multi-user data transmitted by the server to a hand-held terminal will be transmitted via wireless link using a wireless protocol such as Bluetooth or WLAN.

It is further contemplated by the invention that the server is operable as a hand-held device.

### BRIEF DESCRIPTION OF THE DRAWINGS

The accompanying figures best illustrate the details of the method, system, apparatus and computer program product for portable networking of multi-user applications for users of hand-held terminals. Like reference numbers and designations in these figures refer to like elements.

FIG. 1 is a prior art network diagram that illustrates networking of multi-user applications for users of hand-held terminals.

FIG. 2 is a network diagram of illustrating a portable server used for networking of multi-user data for hand-held terminals in accordance with an embodiment of the present application.

FIG. 3 is a more detailed diagram of the portable server in accordance with an embodiment of the present application.

FIG. 4 is a detailed diagram of the portable server in accordance with another embodiment of the present application.

FIG. 5 is a detailed description of the portable server in accordance with another embodiment of the present application.

FIG. 6 is a detailed diagram of the portable server in accordance with another embodiment of the present application.

FIG. 7 is a flow diagram depicting the method in accordance with an embodiment of the present application.

FIG. 8 is a detailed diagram of a hand-held terminal in accordance with an embodiment of the present application.

FIG. 9 is a detailed diagram of the server and energy management circuitry in accordance with an embodiment of the present application.

### DETAILED DESCRIPTION OF THE INVENTION

In the following description of various embodiments, reference is made to the accompanying drawings which form a part hereof, and in which is shown by way of illustration various embodiments in which the invention may be practiced. It is understood that other embodiments may be utilized and structural and functional modifications may be made without departing from the scope of the present invention.

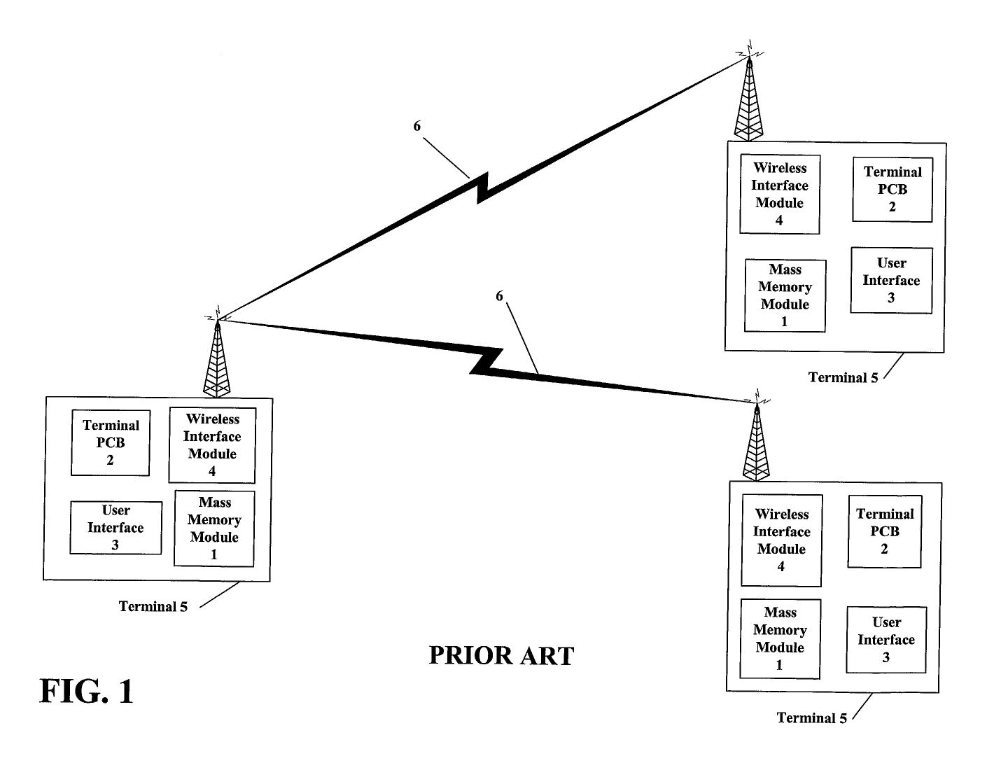

FIG. 1 illustrates a prior art system of networking of multi-user applications using wireless terminals 5. Each of the wireless terminals 5 include a terminal printed circuit board (PCB) 2, wireless interface module 4, a user interface 3 and mass memory module 1. The terminals 5 communicate with each other via a wireless link 6 using a standard wireless protocol. This prior art system requires that the multi-user data that is being communicated between the terminals 5 be stored in the mass memory module 1 within each terminal 5.

In cases were the multi-user applications are more complex, large amounts of memory space is needed. Thus, in order to accommodate these more complex multi-user applications, the mass memory module 1 of the terminals 5 must be large, which increases the size and expense of the terminals 5. However, in order to maintain a reasonable terminal size, there must be limits on the size of the mass memory module 1, which may comprise the operating capability of terminal 5. In the alternative, the more complex multi-user applications may be stored on larger stationary servers (not shown), which may limit the range of the handheld terminals 5.

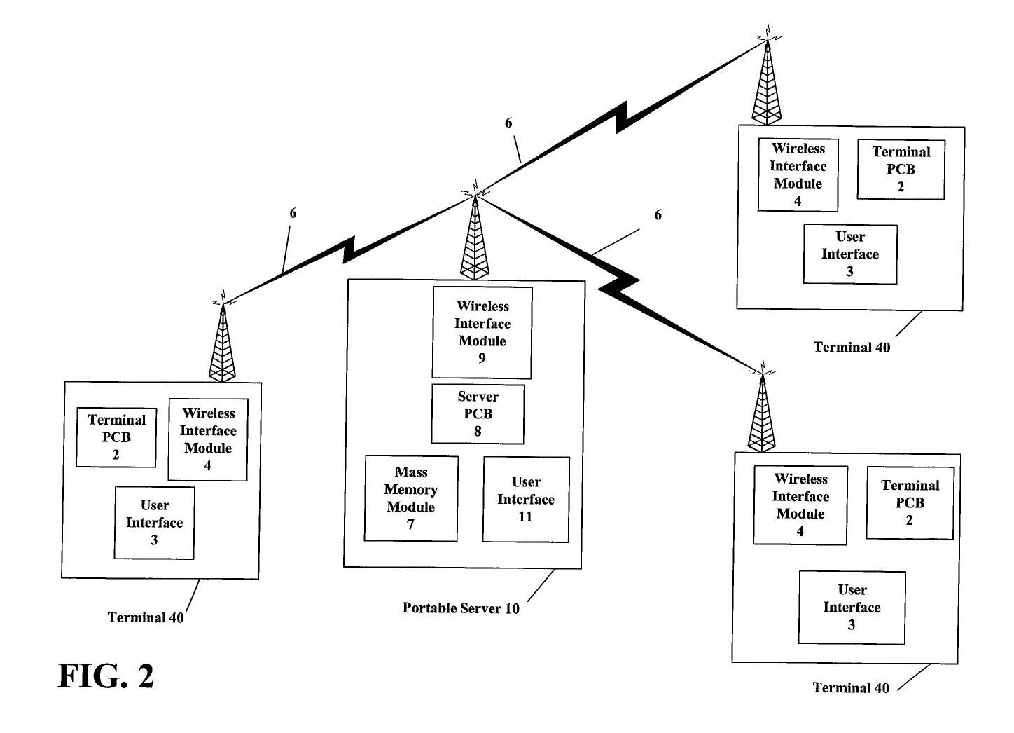

FIG. 2 illustrates an embodiment of the present invention. In FIG. 2, hand-held terminals 40 are in wireless communication with a portable server 10. Each of the terminals 40 in FIG. 2 include a terminal PCB 2, wireless interface module 4 and user interface 3. The terminal PCB 2 includes the necessary architecture to utilize data received by the portable server 10 and support wireless communication. For example, the terminal PCB includes processors, memory and application programs and operating system (not shown). The wireless interface module 4 includes a wireless user interface capable of communication with the portable server 10 using a standard wireless protocol. For example, it is contemplated by the invention that the wireless interface module 4 communicates with the portable server 10 using a Bluetooth standard protocol operating in the 2.4 GHz industrial scientific medical (ISM) band.

The terminal 40 has a user interface 3 that allows a user to request multi-user data from the portable server 10 via the wireless communication link 6. The user interface includes a keypad or similar device that would enable the user to enter instructions or commands to the hand-held terminal 40. The terminals 40 are contemplated to be hand-held and carried by the user.

In contrast to the prior art terminals 5 in FIG. 1, the terminals 40 of the present invention do not need a mass memory module to store multi-user data. Instead, as illustrated in FIG. 2, the system of the present invention provides the use of a separate portable server 10, which includes a mass memory module 7 for storing multi-user data. This allows the terminals 40 to have a more streamline design then the prior art terminals 5. The multi-user data stored in the portable server 10 can be transmitted to a hand-held terminal 40 upon request by the user via the wireless link 6.

The server PCB 8 includes the necessary architecture to store data in the mass memory, process requests by the user utilize data, and transmission of requested data to the terminal as well as support for wireless communications. In pertinent part, the server PCB 8 will include microprocessors, operating system, application programs and random access memory (RAM). It is contemplated by the invention that the server 10 is portable in that the server 10 can be carried by the user of the hand-held terminals. It is further contemplated that the portable server 10 can be reduced in size to be hand-held, similar to the terminal 40.

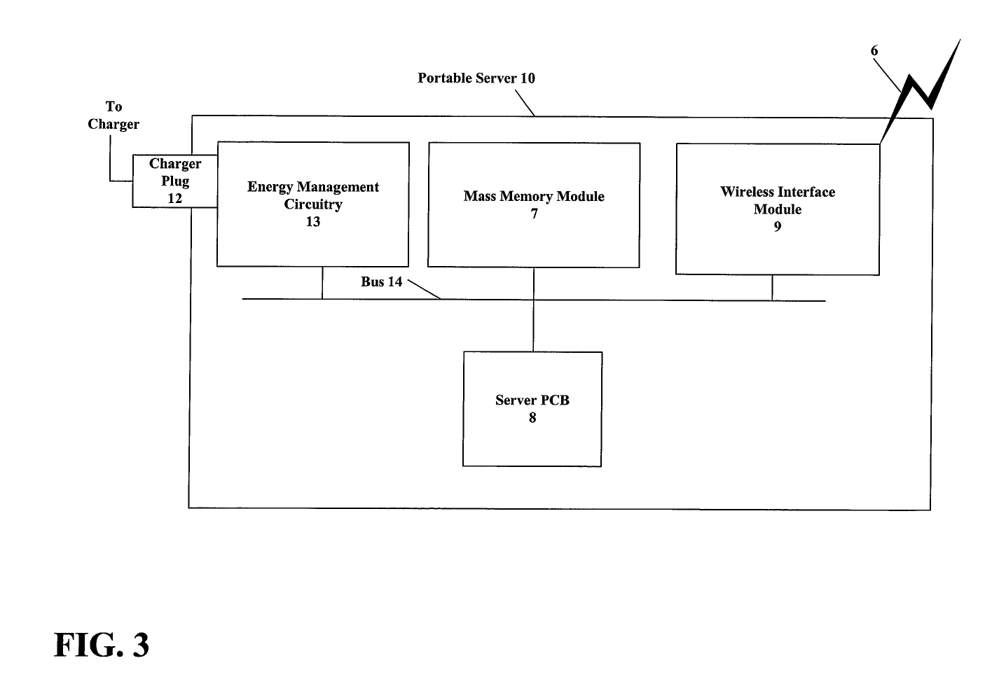

FIG. 3 illustrates a more detailed diagram of the portable server 10 contemplated by the invention. The portable server 10 has its own power supply that is fully rechargeable using a standard electrical charging system (not shown) via a charging plug 12 connected to the energy management circuit 13 of the server 10. The powering of the portable server is controlled by the energy management circuit 13 that provides power to the components of the server via a connection to a common bus 14.

The mass memory module 7 is capable of storing various types of application data that can be requested by a user of a hand-held terminal 40. The multi-user data available is contemplated to include business application data, music application data and games application data. It is contemplated by the invention that for business applications, the portable server 10 is transportable within a business environment providing useful data to office personnel wirelessly in the office environment. For music applications, the server 10 is used essentially as a jukebox that stores music data that is accessible by multiple users of hand-held terminals 40. For game application, the server can store large amounts of data that can be accessed and played by multiple users of the hand-held terminals. The data rates for multi-user games are generally as small as 5 Kbytes/sec, which is useable via a standard 24.4 Kbytes/modem or Bluetooth protocol with data modes less than 128 Kbytes/sec. The mass memory can be either a magnetic or optical storage medium that is exchangeable with a capacity to store at least 500 mbytes of data. SPIE Topical Conference on optical data storage, Technical Considerations For Optical Disks in Cellular Mobile Terminals, Santa Fe, N. Mex., April 2001. The mass memory can also be a solid-state memory such as a flash memory device, a MEMS memory device or the like.

The wireless communication interface module 9 is a standard interface that uses Bluetooth wireless protocol for communicating with the terminals 40. The server should have the minimum hardware needed to share data between the mass memory module 7 and the terminals 40. At a minimum, the server PCB 8 has processors such as a digital signal processor (DSP) or application-specific integrated circuit (ASIC), and random access memory (RAM) to support wireless communication, operating system, and application programs. The communication between server PCB 8 and the components of the server 10 is achieved by connections to the common bus 14. Using the server 10 of the present invention, the most power-consuming hardware and operations are relegated to and performed by the server 10 instead of the terminals 40. The main function of the server is to act as a data transmitter between the mass memory module 7 and the terminals 40. The server 10 can be based in part or in whole on a mobile positioning service (MPS) platform. In particular the wireless interface protocols in the MPS wireless systems.

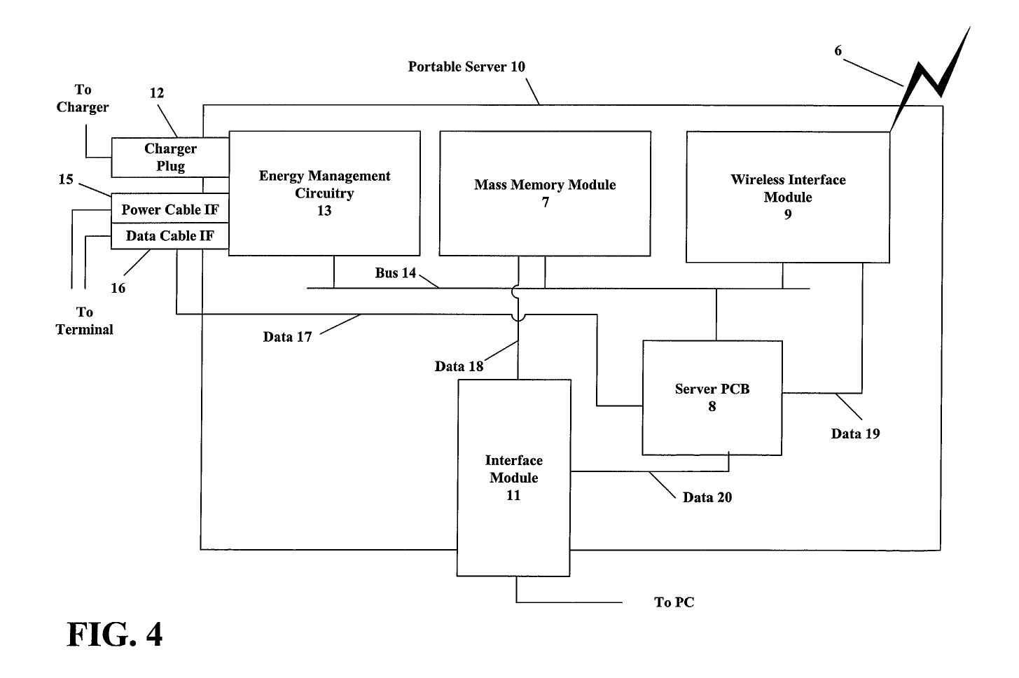

FIG. 4 illustrates another embodiment of the server contemplated by the invention. Specifically, the server in FIG. 4 includes the use of an optional power cable interface 15 and data cable interface 16 connectable to the terminals 40. Using the power cable interface 15, a terminal 40 can be charged through the server 10 via the energy management circuit 13 using the same charger. Additionally, using the data cable interface 16 the communication of data between a terminal 40 and the server 10 can be achieved using the cable connection instead of the wireless link 6. Using the data cable interface 16, a user transmits a request to and receives data from the server via a data line 17 to the server PCB 8. The architecture of the server PCB will process the data request, obtain the data, and then transmit the data to the terminal via the data line 17. The cable interface 16 is used as an alternative to transmitting data via the wireless link 6 when the user prefers not to deplete the rechargeable power supply of the energy management circuitry 13.

Additionally, FIG. 4 illustrates an optional cable connection using an interface module 11 for direct connection from the server 10 to a personal computer or the like (not shown). The connection can be a universal serial bus (USB), or similar connection which is used to access and update data stored in the mass memory 7. For example, if the user wished to add games or music to the mass memory, the new data can be downloaded using a connection to the interface module 11. Additionally, the user can delete data from the mass memory 7 using the same the same connection.

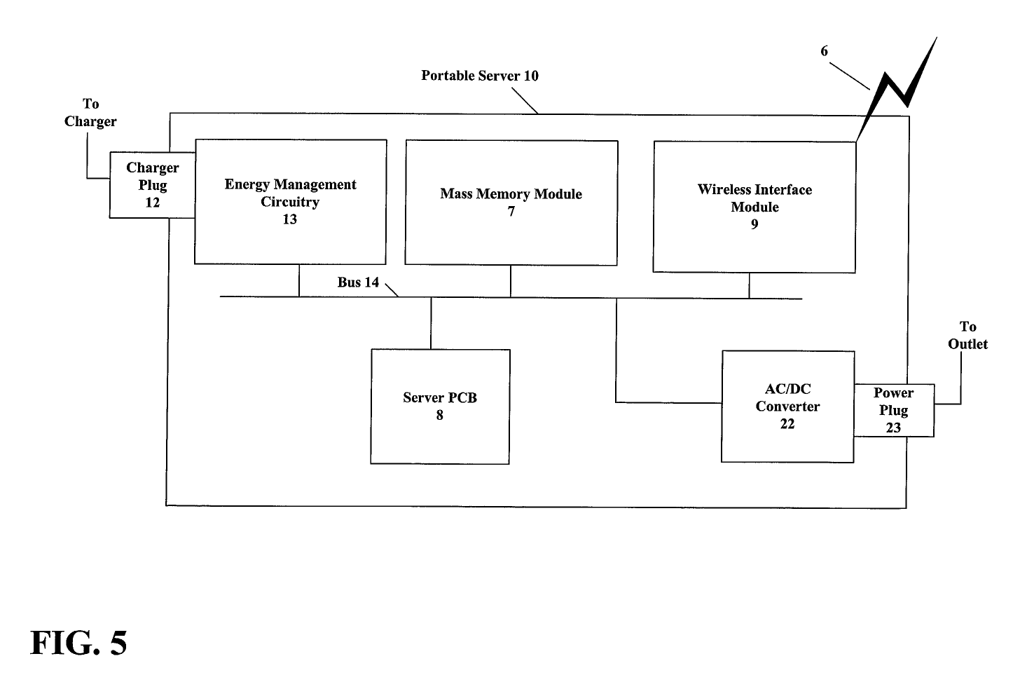

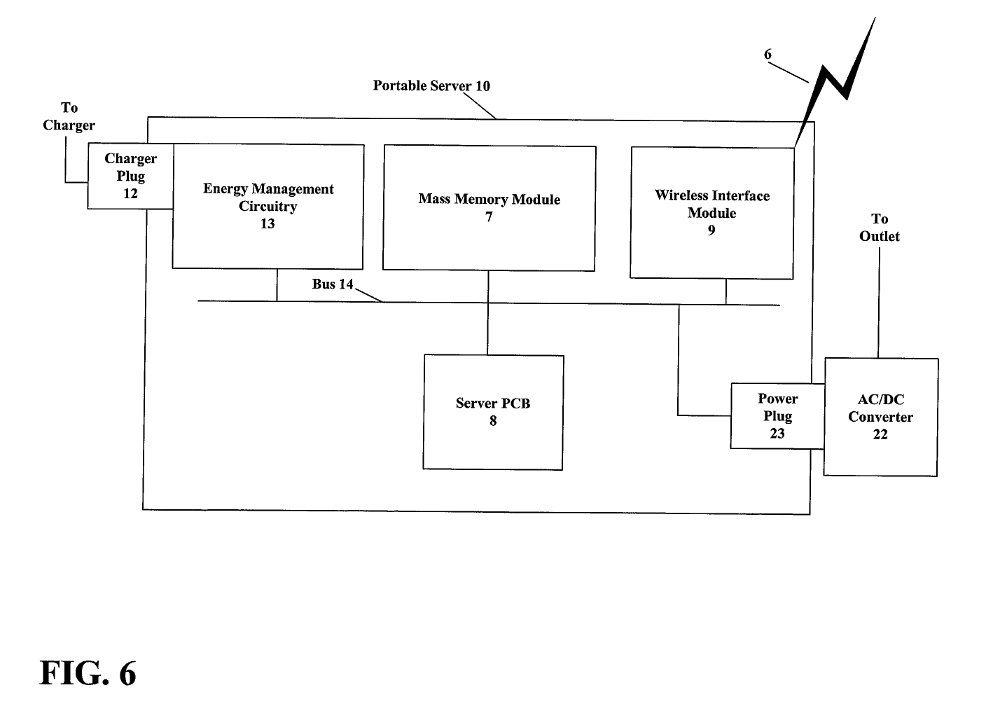

FIG. 5 illustrates another embodiment of the server that includes the use of an optional power connection. The power connection includes an AC/DC converter 22 that is part of the server architecture and connected to the components of the server via the common bus 14. The AC/DC converter 22 is also connected to a power plug 23, which is connectable to a standard AC wall outlet. Instead, the AC/DC converter 22 converts the standard AC from the wall outlet to DC for charging of the rechargeable power supply of the server 10. FIG. 6 illustrates and alternative to using the optional power connection. The main difference from the configuration of FIG. 5 is that the AC/DC converter of FIG. 6 is separate from the server 10 architecture. The AC/DC converter is removably connected to the power plug 23 of the server.

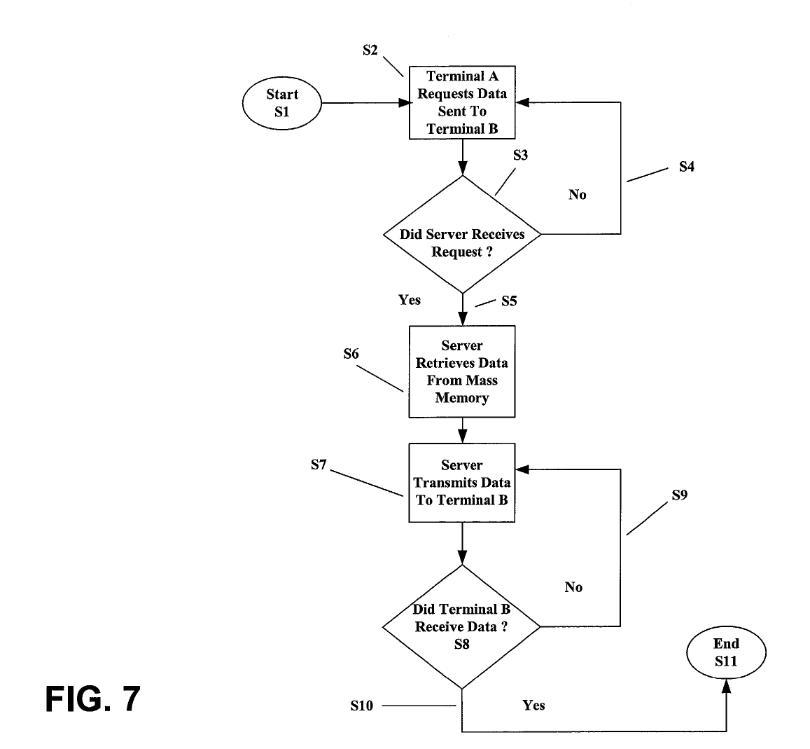

FIG. 7 illustrates the method in accordance with an embodiment of the present invention. In step S1, the user of a hand-held terminal 40 requests the use of data stored in the mass memory module 7 of the server 10. The user sends a request using the user interface on the hand-held terminal 40. The request is transmitted either wirelessly using the wireless interface module 4 of the terminal or by using the optional data cable interface 16. In step S2, the request is received by the server 10. In step S5 the server PCB 8 will acknowledge receipt of the request or conversely in step S4 the server 10 will indicate to the user that the request must be sent again. Once the server has successfully received the request, the server in step S6 will retrieve the requested data stored in mass memory module 7. In step S7, the server 10 sends the requested data to the hand-held terminal via a wireless link 6 or using the optional data cable interface 16. In step S9, if the transmission fails, the server sends the data again. In step S10, once the user has successfully received the data, the data can be utilized by the user via the hand-held device 40. In step S11, once there is successful transmission of the data, the process is terminated. Upon the request for additional data by the user of a hand-held device, steps S1-S11 are repeated.

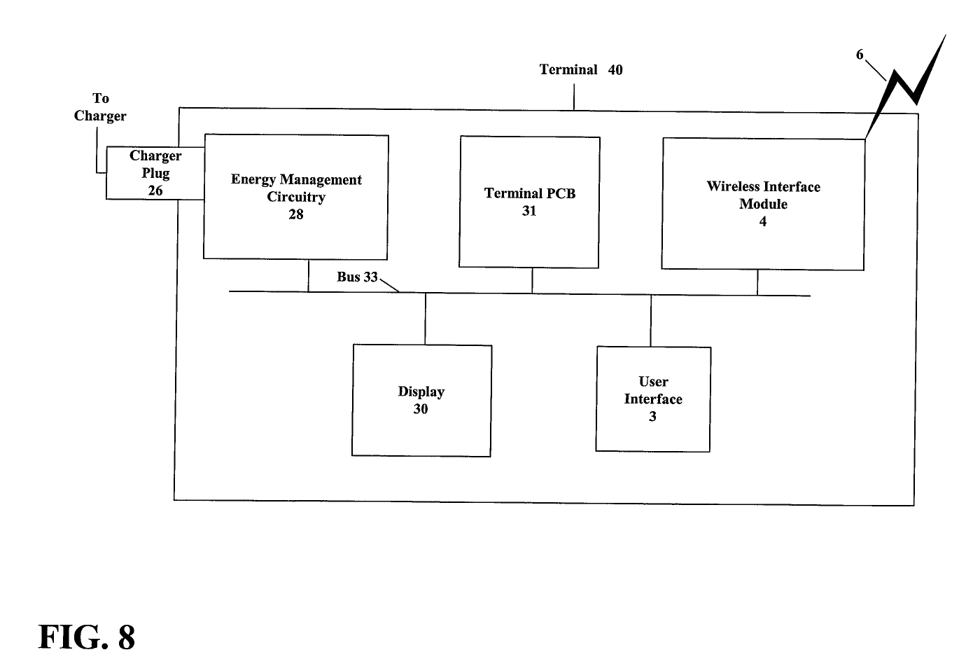

FIG. 8 illustrates in more detail the terminal 40 in accordance with an embodiment of the invention. Similar to the server 10, the terminal 40 will be rechargeable via a charger and energy management circuit 28 and charger plug 26. The other components of the terminal 40 include a terminal PCB 2, display 30, user interface 3 and wireless interface module 4. All the components of the terminal 40 are in communication with each other via the bus 33. The terminal PCB 2 includes processors, operating system, application programs and memory. It is contemplated that the terminal 40 of the invention has RAM memory sufficient to execute the data transmitted by the server 10. The terminal may be any network management protocol (NMP) product incorporating the capability of communicating using a wireless protocol such as Bluetooth protocol via a wireless communication link 6. The wireless interface is a standard wireless interface with the capability of using Bluetooth protocol for communicating with the server 10. The user of the terminal 40 may send a request for data stored in the mass memory 7 of the server 10 and interact with the terminal 40 using the user interface 3. The user interface 3 is a keypad, touch screen or the like, which allows user interaction with the terminal 40. Additionally, the user of the terminal 40 may view data communicated between the terminal 40 and server using the display 30.

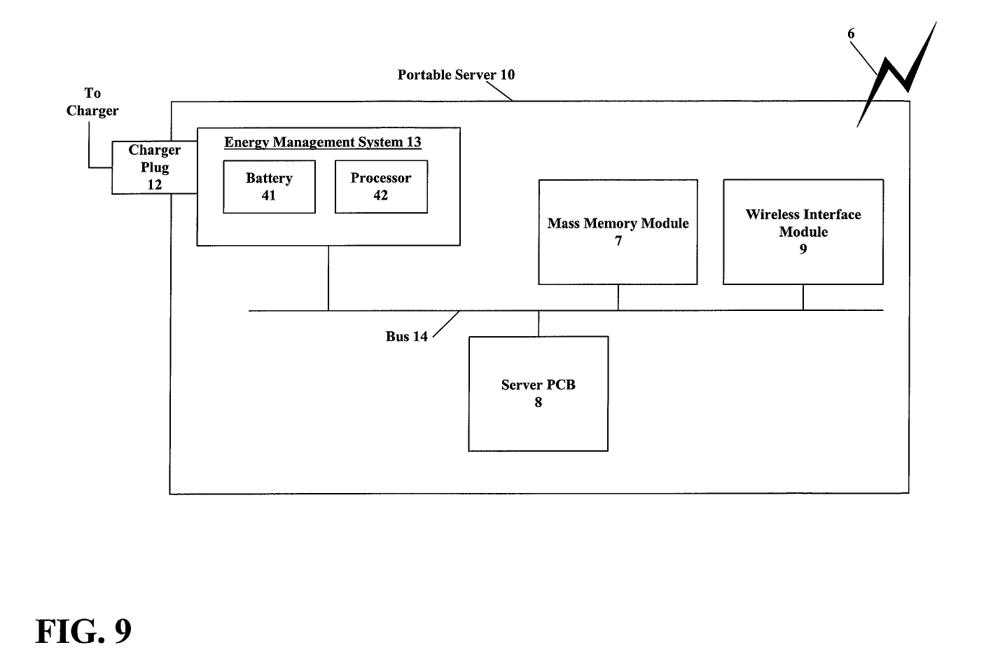

FIG. 9 illustrates in more detail the energy management circuit 13 in accordance with an embodiment of the invention. The energy management system 13 is connected to a charger via the charging plug 12. The energy management system architecture includes a rechargeable battery 40 and processor 42. The processor of the energy management system 13 is able to provide power to the other components of the server 10 via the bus 14. The charging of the system can be either on or off as controlled of the energy management system 13.

Presently, there is no existing technology that would be suitable for mass storage (>500 mbytes) in NMP products. The advantage of the present invention as described herein is that the portable server 10 may be implemented almost completely with existing technology without requiring major redesigning of existing terminals. Additionally, using the present invention it is possible to optimize the allocation of resources between the terminals 40 and the portable server 10.

Although illustrative embodiments have been described herein in detail, its should be noted and understood that the descriptions and drawings have been provided for purposes of illustration only and that other variations both in form and detail can be added thereupon without departing from the spirit and scope of the invention. The terms and expressions have been used as terms of description and not terms of limitation. There is no limitation to use the terms or expressions to exclude any equivalents of features shown and described or portions thereof.

We claim:

1. A system for portable networking of multi-user applications, comprising:
at least one wireless terminal; and
a portable server including a mass memory module to store and communicate data to said at least one wireless terminal;
wherein a wireless protocol communicates the data between said server and said at least one wireless terminal via a wireless link.

2. The system of claim 1, wherein said at least one wireless terminal further comprises:
a user interface that allows the user to request data from said mass memory module;
a wireless communication interface for communicating data between said portable server and said at least one wireless terminal.
a buffer memory for storing instruction for executing the data received by said at least one wireless terminal;
a processor in communication with said buffer memory for executing instruction stored in said buffer memory; and
a display for viewing the data received from said portable server.

3. The system of claim 1, wherein said server further comprises:
a mass memory module for storing data used by said at least one wireless terminal;
a processor in communication with said mass memory module that executes requests for data by said at least one wireless terminal and locates data in said mass memory module; and
a wireless communication interface for communicating data between said mass memory module and said at least one wireless terminal.

4. The system of claim 1, wherein said wireless protocol for transmitting data to said wireless terminal is a Bluetooth protocol.

5. The system of claim 1, wherein said at least one wireless terminal and said portable server are both hand-held devices.

6. The system of claim 1, wherein said system further comprises an optional USB plug for connecting said server to a personal computer.

7. The system of claim 1 wherein said system further includes an optional plug as a data cable connection between said at least one wireless terminal and said server.

8. The system of claim 1, further comprising an optional plug as a power cable connection between said server and said at least one wireless terminal.

9. The system of claim 1, further comprising a single optional cable for both power and data transfer between said portable server and said at least one wireless terminal.

10. The system of claim 1, wherein said terminal is a cellular telephone, a satellite telephone, a personal digital assistant or a Bluetooth device.

11. The system of claim 1, wherein said at least one wireless terminal device comprises a plurality of wireless terminals in communication with and receiving data from said potable server.

12. The system of claim 1, wherein said mass memory is either a magnetic storage device, an optical storage device or solid-state storage device.

13. The system of claim 12, wherein said mass memory module is exchangeable.

14. An apparatus for portable networking of multi-user applications, comprising:
a battery to supply power to the electrical components of said portable server;
a charging system in communication with said battery for charging said battery;
a mass memory module for storing data used by at least one wireless terminal;
at least one processor in communication with said mass memory for locating and retrieving data stored in said mass memory module; and
wireless interface for executing a wireless protocol and communicating the data between said mass memory and at least one wireless terminal.

15. The apparatus of claim 14, wherein said battery is rechargable.

16. The apparatus of claim 14, wherein said charging system is a plug that charges the apparatus with the same charger used to charge said at least one wireless terminal.

17. The apparatus of claim 14, wherein said charging system is a wall plug, and AC/DC converter.

18. The apparatus of claim 14, wherein said AC/DC converter is either fixed to the apparatus or removably connectable to the apparatus.

19. The apparatus of claim 14, wherein said apparatus is a hand-held server.

20. The system of claim 14, wherein the wireless protocol used for communication between the apparatus and said at least one wireless terminal device is a Bluetooth protocol.

21. The apparatus of claim 14, wherein said mass memory is a magnetic storage device or an optical storage device.

22. The apparatus of claim 21, wherein said mass memory fully exchangeable.

23. The apparatus of claim 14, wherein said apparatus further comprises an optional USB plug for connecting to a personal computer.

24. The apparatus of claim 14, wherein said apparatus further comprises an optional plug as a data cable connection to said at least one wireless terminal device.

25. The apparatus of claim 14, wherein said apparatus further comprising an optional plug as a power cable connection to said at least one wireless terminal device.

26. The apparatus of claim 14, wherein said apparatus further comprising an optional cable for both power and data connection to said at least one wireless terminal.

27. The apparatus of claim 14, wherein said at least one wireless terminal device is a cellular telephone, a satellite telephone, a personal digital assistant or a bluetooth device.

28. The apparatus of claim 14, wherein said at least one wireless terminal comprises a plurality of wireless terminal devices using said wireless protocol.

29. The method for portable networking of multi-user application, comprising:
storing multi-user data in the mass memory of portable server;
initiating wireless communication between said portable server and at least one wireless terminal device;
transmitting data stored in said mass memory to said wireless terminal device using a wireless protocol; and
executing of said multi-user data by said terminal device transmitted by said portable server.

30. The method of claim 29, wherein said wireless terminal device comprises:
a user interface that allows the user to request data from said mass memory module;
a wireless communication interface for communicating data between said portable server and said wireless terminal.
a buffer memory for storing instruction for executing the data received by said wireless terminal;
a processor in communication with said buffer memory for executing instruction stored in said buffer memory; and
a display for viewing the data received by said portable server.

31. The method of claim 29, wherein said portable server further comprises:
a mass memory module for storing data used by said at least one wireless terminal;
a processor in communication with said mass memory module that for executes requests for data by said wireless terminal and locates data in said mass memory module; and
a wireless communication interface for communicating data between said mass memory module and said wireless terminal.

32. The method of claim 29, wherein said wireless protocol is a Bluetooth protocol.

33. The method of claim 29, wherein said wireless terminal and said portable server are both hand-held devices.

34. The method of claim 29, further comprising providing data and power to said server using an optional USB plug connection between said portable server and a personal computer.

35. The method of claim 29, further comprising providing data to said wireless terminal device using an optional plug connection between said portable server and said wireless terminal.

36. The method of claim 29, further comprising providing power to said wireless terminal using an optional plug connection between said portable server and said wireless terminal.

37. The method of claim 29, further comprising providing both power and data to said wireless terminal using a single optional plug connection between said portable server and said terminal.

38. The method of claim 29, wherein said terminal is a cellular telephone, a satellite telephone, a personal digital assistant or a Bluetooth device.

39. The method of claim 29, further comprising communicating data stored in the mass memory to a plurality of wireless terminals.

40. The method of claim 29, wherein said mass memory is a magnetic storage device, an optical storage device, solid-state storage device.

41. The method of claim 40, wherein said mass memory is exchangeable.

42. A computer program product for portable networking of multi-user applications, comprising:
a computer readable medium;
program code in said computer readable medium storing multi-user data in the mass memory of portable server;
program code in said computer readable medium initiating wireless communication between said portable server and at least one wireless terminal device;
program code in said computer-readable medium for communicating data stored in said mass memory to at least one said wireless terminal device using a wireless protocol for execution by said wireless terminal.
